(19) United States
(12) Patent Application Publication
(10) Pub. No.: US 2019/0193928 A1
(43) Pub. Date: Jun. 27, 2019

(54) MULTI-INGREDIENT EPHEMERAL BEVERAGE POD FOR MAKING A BEVERAGE

(71) Applicant: PepsiCo, Inc., Purchase, NY (US)

(72) Inventors: Martin Eduardo BROEN, New York, NY (US); Girish Nilkanth DESHPANDE, Carmel, NY (US); Bruno TELESCA, Sandy Hook, CT (US)

(21) Appl. No.: 16/224,460

(22) Filed: Dec. 18, 2018

Related U.S. Application Data
(60) Provisional application No. 62/609,120, filed on Dec. 21, 2017.

(51) Int. Cl. B65D 85/804

(52) U.S. Cl. CPC B65D 85/8046

(57) ABSTRACT

Aspects of this invention relate to an ingredient pod for making a beverage. The pod may include multiple layers, and each layer may include a beverage ingredient. The pod may be surrounded by a solid or gel outer layer, and the inner layers may be gel, solid, or liquid. Each layer may release into a liquid to form a ready-made beverage, providing a different flavor, smell, or ingredient. The pod may also be a multi-chamber pod. Each chamber may include one or more layers, and each layer may include a beverage ingredient. Other aspects of the disclosure relate to a method for making a beverage using a pod. Each layer or chamber of the pod may be activated differently depending on the application or the type of beverage.

### CROSS-REFERENCE TO RELATED APPLICATION

This application claims the benefit of U.S. Provisional Application No. 62/609,120, filed Dec. 21, 2017, which is incorporated herein in its entirety by reference thereto.

### BACKGROUND

### Field of the Invention

The described embodiments relate generally to pods used for making beverages in-home, and methods for using the pods.

### BRIEF SUMMARY

Aspects of the disclosure include an ephemeral ingredient pod for making a beverage.

The pod may have multiple layers, and each layer may be a different ingredient. Each ingredient may be released or dissolved into a liquid to form a beverage. Similarly, the pod may have multiple chambers that each contain one or more ingredients. The ingredients may be solids, liquids, or gels. The ephemeral pods may be edible and ready to consume upon removal from the packaging, or the pods may be combined with a liquid to produce a beverage.

The ephemeral pod may have a membrane removably disposed exterior to the outermost layer so that the membrane entirely covers the pod, and the membrane may be disposable and biodegradable. The pod may also have other membranes that separate one layer from another. These other membranes may be edible or dissolvable.

In other aspects, the pod may be configured to dissolve only in a certain type of liquid, such as hot or cold, acidic or alkaline, and carbonated or still. The pod may be activated by a beverage at a certain temperature, or each layer or chamber within the same pod may be activated differently based on the application. The pod may be used to create a ready-made beverage or provide additional flavoring to a beverage by releasing the various ingredients into a liquid.

In other aspects, a beverage is made by using the pod with a device that is compatible with the pod. The device may provide a liquid that contacts the pod to begin the beverage making process.

### BRIEF DESCRIPTION OF THE FIGURES

FIG. 1A shows a cup with liquid and multiple ephemeral beverage pods.

FIG. 1B shows a cup with liquid and one ephemeral beverage pod.

FIG. 2A shows a cutaway view of an ephemeral beverage pod with two layers.

FIG. 2B shows a cutaway view of an ephemeral beverage pod with three layers.

FIG. 3A shows a cross-sectional view of an ephemeral beverage pod having four layers, with the innermost layer centered in the pod.

FIG. 3B shows a cross-sectional view of an ephemeral beverage pod having four layers, with the innermost layer positioned off-center in the pod.

FIG. 4 illustrates a protective layer covering an ephemeral beverage pod and being peeled away from the pod.

FIGS. 5A and 5B each show an ephemeral beverage pod with multiple chambers.

FIG. 5C shows a cross-sectional view of an ephemeral beverage pod having two adjacent chambers.

FIGS. 6A-6D each shows a beverage-making apparatus that uses an ephemeral beverage pod to produce a beverage.

### DETAILED DESCRIPTION

Depending on their use, demands on food and beverage packaging can vary widely. For example, items used and sold in the food and beverage industry may be packaged in single-use packages. Existing packaging is generally used as merely a vessel in which to carry or protect the food or beverage contained in the packaging before the food or beverage is consumed by the end user.

Ephemeral beverage pods described herein do more than simply contain their contents; they provide a single-use, environmentally-friendly, convenient, and hygienic packaging solution that is dissolvable, edible, or compostable. The ephemeral pod may be single-serve or multi-serve. For example, edible or biodegradable packaging solutions may provide a way for packaging to be made and used in an environmentally friendly way, or to serve as more than just a vessel and instead be part of the product itself, or the product's delivery. Such edible or biodegradable packaging can be used to create pods that are designed for easy, in-home or on-the-go beverage making and still provide optimum hygiene and structure without significant waste.

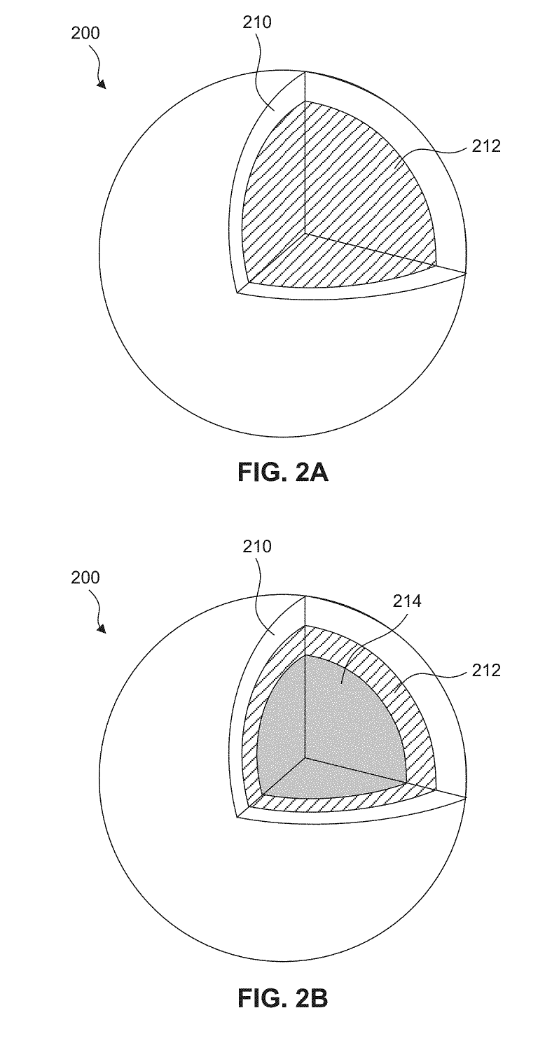

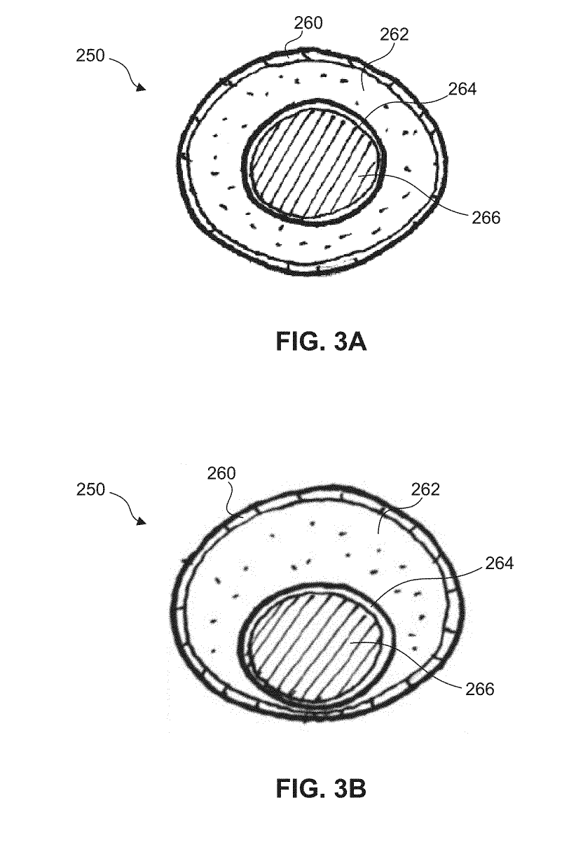

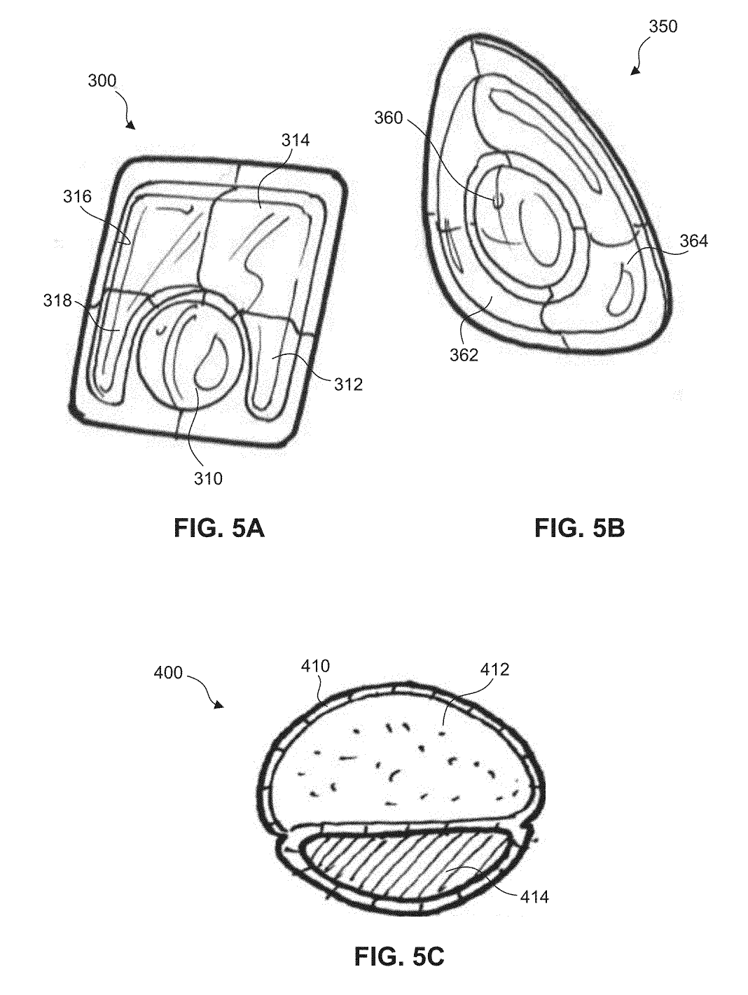

Ephemeral pods may contain multiple nested layers, as shown in FIGS. 2A-3B, or multiple chambers, as shown in FIGS. 5A-5C. Each layer or chamber may be a different ingredient that can be released into a liquid to form a beverage that can be consumed directly by the user. One or more layers may be a film or membrane that contains or separates two layers or chambers from each other.

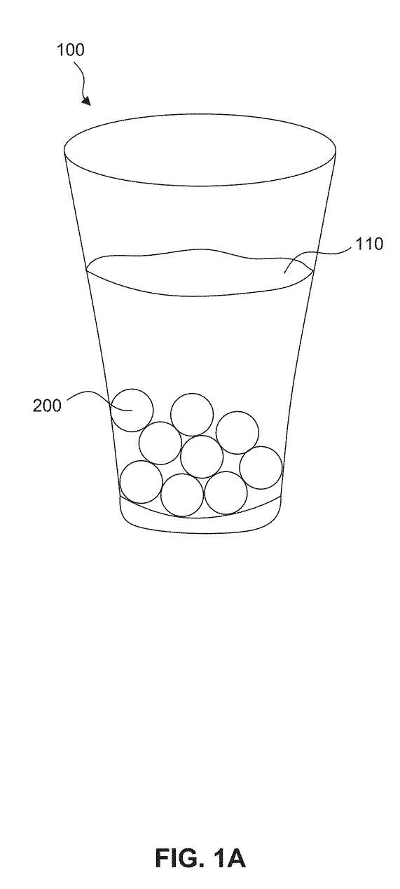

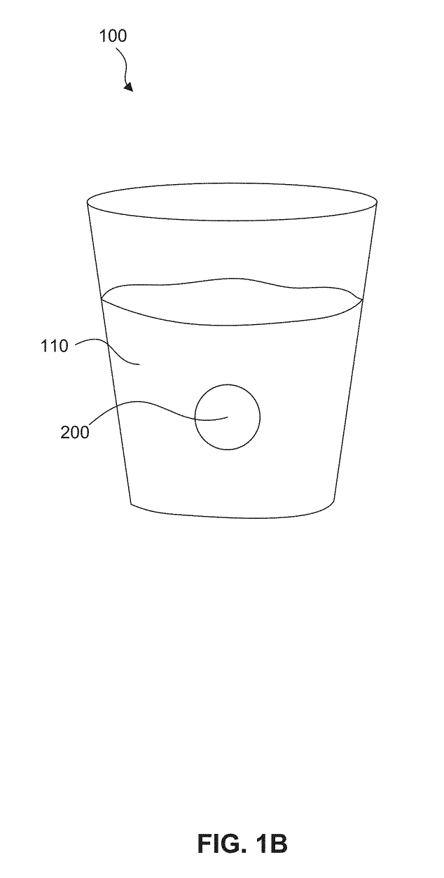

As shown in FIGS. 1A and 1B, a cup 100 may contain a liquid 110, and one or more ephemeral pods 200 placed in liquid 110. Liquid 110 may be a beverage (e.g., a soft drink) or a beverage ingredient (e.g., water). Ephemeral pods 200 may release their contents into the liquid to create a beverage or to change the characteristics of an existing beverage. Liquid 110 may be water, carbonated water, juice, coffee, tea, soda, or any other liquid suitable for drinking. Ephemeral pods 200 may have various configurations and uses, as described in more detail below.

FIGS. 2A and 2B show cutaway views of exemplary embodiments of ephemeral beverage pod 200. As shown in FIGS. 2A and 2B, pod 200 may contain multiple layers. For example, pod 200 may have an outermost layer 210 that defines an outer surface of pod 200 and a layer 212 that defines as an inner core or inner layer of pod 200, as shown in FIG. 2A. As another example, pod 200 may have layers 210, 212, and 214, as shown in FIG. 2B. Pod 200 may include additional inner layers than what is shown in FIGS. 2A and 2B.

Inner layers 212, 214 may be liquid or solid beverage ingredients. Each of layers 210, 212, and 214 may be a liquid, solid, or gel. Outermost layer 210 may be a solid that contains the inner layers (e.g., layers 212 and 214 in FIG. 2B). Outer layer 210 will generally be a solid, since it contains the layers interior to it and since it is the primary layer that interacts with an external environment. When handling ephemeral beverage pod 200 a user may touch outer layer 210. When ephemeral beverage pod 200 is in a liquid, outer layer 210 may be the first to interact with the liquid. And in cases where outer layer 210 seals inner layers (e.g., layers 212, 214) off from an exterior environment, outer layer 210 may be punctured, dissolved, or otherwise broken to release its contents.

In some embodiments, pod 200 may have two or more layers, as shown in FIGS. 2A and 2B. Layer 210 may be one flavor, layer 212 may be a second flavor, and layer 214 may be a third flavor. In some embodiments, layers 210, 212, and 214 of pod 200 have varying ingredients. For example, the ingredient may be a concentrate, a flavor, a stimulant, a nutrient, a dietary supplement, or an ingredient that causes a CO₂ reaction that carbonates a beverage. Outer layer 210 may be a solid having a first flavor, while inner layers 212 and 214 may have different flavors. For example, pod 200 may have alternating savory and sweet layers 210, 212, and 214.

In some embodiments, outer layer 210 interacts with the internal layers (e.g., layers 212 and 214) before the pod 200 is used to create a beverage. For example, outer layer 210 may contain nutrients or ingredients that enrich or provide nutrients to the internal layers over time. In other words, nutrients contained in layer 210 may transfer to the internal layers 212, 214 or may otherwise affect the properties of the internal layers. For example, the internal side of outer layer 210 may contact layer 212, and the interaction between the internal side of outer layer may transfer some of the nutrients or ingredients from outer layer 210 to layer 212. The nutrients may be transferred between layers (e.g., from layer 210 to layer 212) by, for example, a mass-transfer process. For example, the nutrients may have a higher concentration in one layer (e.g., layer 210) and a lower concentration in another layer (e.g., layer 212). This concentration differential may create a driving force for the nutrient to move from one layer to another layer. The solubility of the nutrient may also affect the transfer of the nutrient. For example, if the nutrient is soluble in layer 210 and layer 212, such a concentration driving force may enable transfer of nutrients from layer 210 to layer 212.

The nutritional benefit may be transferred to the inner layers over time. The rate at which the nutrient transfers may be dependent on the differential between the nutrient concentration in one layer (e.g., layer 210) and the adjacent layer (e.g., layer 212) that creates a driving force. Generally, a higher driving force corresponds to a faster transfer time. The rate of transfer can be tailored by changing the concentration in each layer, adjusting the solubility of the nutrients in each layer, changing the pod temperature, and changing the surface area of contact between each layer. For example, a smooth interface between layers will have less surface area than a rough interface between the layers. A higher surface area of contact between the layers will increase the rate of transfer of the nutrient. Additionally, the nutrient may be chemically altered, which can increase the rate of transfer.

Further, the rate of transfer may change over time. For example, the concentration driving force may be highest before significant nutrient transfer has occurred (due to the higher concentration differential). As more and more nutrient transfer has occurred, the differential decreases, which in turn decreases the concentration driving force, lowering the rate of transfer.

Additionally, outer layer 210 may be a biodegradable layer that protects the internal layers from the external environment and from ultraviolet (UV) radiation. In some embodiments, layer 210 provides these protective and nutritional benefits to the internal layers and is also edible and ready to be consumed by the user (e.g., also providing nutritional benefit directly to the user through the consumption).

In some embodiments, at least one of layers 210, 212, and 214 includes an ingredient that causes a CO₂ reaction. This ingredient may include food-grade bicarbonates (e.g., sodium bicarbonate or potassium bicarbonate) or salts of tartrates (e.g., sodium tartrate or potassium tartrate), or any other ingredient suitable for causing a CO₂ reaction. In an acidic aqueous media, the sodium bicarbonate may react with any weak (or strong) acid to produce CO₂ gas at room temperature. Examples of acidic media include water with added vinegar, citric acid, or any acidic fruit juices (e.g., orange juice or lemon juice). The ingredient may also include a mixture of a weak food-grade acid and a corresponding base, for example, citric acid with sodium bicarbonate. Other weak food-grade acids having low water solubility may be used, including malic acid, tartaric acid, adipic acid, and fumaric acid. Other base components include potassium bicarbonate, sodium carbonate, or potassium carbonate. Additionally, the ingredient may include a food-grade binder (e.g., sorbitol, xylitol, or lactose) to maintain homogeneity until the ingredient is released into the beverage.

Each of layers 210, 212, and 214 may be released into liquid 110 to form a beverage. In the case of solid or gel layers, the layers may dissolve in liquid 110, and in the case of liquid layers, the layers may release into liquid 110 and mix into liquid 110. FIG. 2A shows pod 200 with two layers and FIG. 2B shows pod 200 with three layers, but it is to be understood that pod 200 may have more than three layers. These layers may be used to make a beverage by placing pod 200 in liquid 110, as shown in FIGS. 1A and 1B. In some embodiments, outer layer 210 may be removed or punctured before pod 200 is placed in liquid 110. Layer 210 may dissolve after pod 200 is placed in liquid 110 (e.g., immersed in liquid 110), exposing inner layers (e.g., layers 212 or 214) to liquid 110. Each layer that is exposed may add ingredients to the beverage. In some embodiments, all of the layers of pod 200 dissolve (e.g., pass into solution) with water to create a ready-made beverage. In some embodiments, one or more of the layers of pod 200 do not dissolve and remain in liquid 110 after all the layers have been release. In this case, the layer that did not dissolve in liquid 110 may be a biodegradable substance that can be poured down the drain, composted, or otherwise disposed of.

FIGS. 3A-3B show exemplary ephemeral beverage pod 250. The layers of ephemeral beverage pod 250 may be solids, liquids, or gels. For example, FIGS. 3A-3B show cross-sections of various configurations of pod 250 having multiple layers. As shown in FIGS. 3A and 3B, ephemeral beverage pod 250 may include layers 260, 262, 264, and 266. In some embodiments, layers 260, 262, 264, and 266 are a gel, concentrate, gel, and solid, respectively. Layer 264 separates layer 262 from layer 266, and layer 260 separates layer 262 from an external environment or from the liquid in which pod 250 will be placed. In some embodiments, layer 260 is a gel, layer 262 is a concentrate, layer 264 is a gel, and layer 266 is a solid. Further, gel layer 260 may allow for multiple single-serve pods to be housed in the same packaging.

In some embodiments, layer 260 is a first membrane layer, layer 262 is a first concentrate, layer 264 is a second membrane layer, and layer 266 is a second concentrate layer. Layers 260 and 264 may each be biodegradable. Layers 262 and 266 may both be ingredients (e.g., concentrates), and each may be a different beverage ingredient.

The gel used in gel layers 260 and 264 (or in any other layer described herein) may be a semi-solid layer and may be any gel suitable for contact with edible ingredients, or any gel suitable for human consumption. Additionally, the gel may be any gel suitable for containing a liquid or a solid without leaking or breaking. The gel may be edible or dissolvable and may include different characteristics depending on the type of beverage to be made. The gel may be made of materials such as plant-based calcium (e.g., calcium derived from marine algae containing high levels of calcium), polysaccharides (e.g., starch, cellulose, gelatin, chitosan), gelatin-like substances obtained from algae (e.g., agar derived from seaweed), milk-based proteins (e.g., casein), or combinations thereof.

Layers 260 and 264 may be gel layers. In some embodiments, layers 260 and 264 are the same gel. In some embodiments, layers 260 and 264 are different gels. Layers 260 and 264 may each be a gel and serve as a membrane, separating layer 266 from layer 262 and layer 262 from external exposure. In some embodiments, layers 260 and 264 are membranes that do not add ingredients to the beverage, but rather provide a barrier that prevents exposure of the ingredients until the user uses pod 250. Though specific examples are provided, layers 260, 262, 264, and 266 may be any suitable combination of solids, liquids, and gels.

The gel layers may be used to control the release of the various ingredients of pod 200. For example, concentrate layer 262 may only dissolve after gel layer 260 dissolves. Following the release of concentrate layer 262 into the beverage, gel layer 264 will be exposed to the beverage. Gel layer 264 may be configured to immediately released in the beverage upon exposure to the beverage, or may be configured to release slowly or after a certain amount of exposure to the beverage. In that way, the release of solid layer 266 into the beverage can be controlled.

Additionally, layer 266 (e.g., a solid layer 266) may be positioned at the center of pod 250, as shown in FIG. 3A, or off center within pod 250, as shown in FIG. 3B. If layer 266 is positioned off center, as shown in FIG. 3B, layer 262 may dissolve from the outside in, exposing solid layer 266 before all of layer 262 has dissolved. Thus, the position of layer 266 is another way to control the release of ingredients into the beverage.

In some embodiments, layers 260 and 264 are disposable membrane layers and layers 262 and 266 are each a different liquid layer. Layers 264 and 266 may be suspended in liquid layer 262 and move around in liquid layer 262 due to forces of gravity. For example, FIGS. 3A and 3B show layers 264 and 266 in different positions.

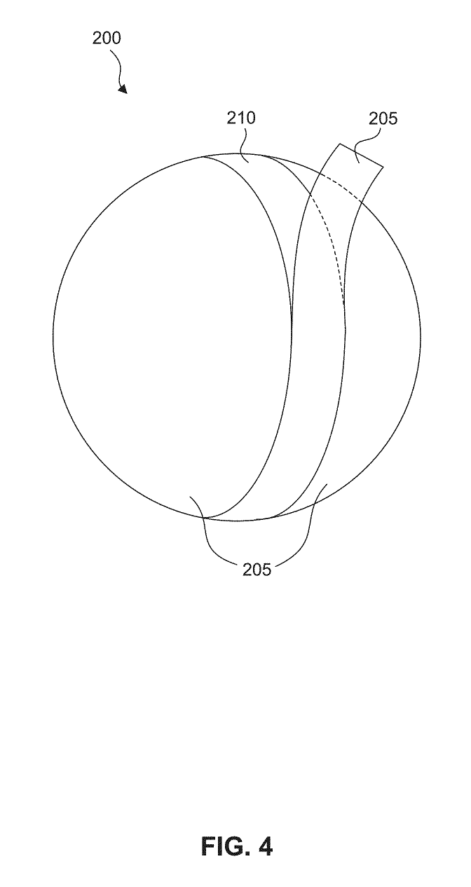

Pod 200 may also include a protective layer 205 that covers outer layer 210. Protective layer 205 may be peeled off prior to using pod 200. For example, any of the pod configurations described herein, including pods 200, 250, 300, 350, or 400, may contain an additional protective layer 205 as described herein. Protective layer 205 may be an environmentally-friendly and food-safe film that covers pod 200 and prevents any exposure of the rest of pod 200 to a beverage or external substances or contaminants. FIG. 4 illustrates protective layer being peeled off of pod 200 to expose outer layer 210.

In some embodiments, protective layer 205 protects the rest of pod 200 (i.e., the portion of pod 200 contained within and covered by protective layer 205) from contamination during shipping or storage. Protective layer 205 may also prevent the rest of pod 200 from being exposed to UV radiation and maintain freshness of its ingredients for a longer period of time. Covering pod 200 with protective layer 205 allows for multiple pods 200 to be stored together in a single container with only their protective layers 205 contacting each other. This can be beneficial when pods 200 are transported or sold in multipacks containing numerous single-serve pods. Each pod 200 may be safely stored until protective layer 205 is removed by the user. After removal of protective layer 205, the rest of pod 200 can be exposed to the beverage.

Protective layer 205 may be a layer that is disposed of following removal by composting or rinsing down the drain, for example. Protective layer 205 may be edible, compostable, or dissolvable. In some embodiments, protective layer 205 is edible and includes materials such as plant-based calcium (e.g., calcium derived from marine algae containing high levels of calcium), polysaccharides (e.g., starch, cellulose, gelatin, chitosan), gelatin-like substances obtained from algae (e.g., agar derived from seaweed), milk-based proteins (e.g., casein), or combinations thereof. In some embodiments, protective layer 205 is dissolvable and includes water-soluble synthetic polymers (e.g., polyvinyl alcohol), thermoplastic polymers (e.g., polylactic acid), or cellulose esters (e.g., cellulose acetate or nitrocellulose). In some embodiments, protective layer 205 is compostable and includes polyhydroxyalkanoates (e.g., poly-3-hydroxybutyrate (PHB), polyhydroxyvalerate (PHV), or polyhydroxyhexanoate (PHH)), cellulose esters (e.g., cellulose acetate or nitrocellulose), or polyanhydrides. Protective layer 205 may also include any water-soluble material that is considered generally recognized as safe (“GRAS”) by the U.S. Food and Drug Administration (e.g., on the FDA's GRAS list).

In some embodiments, protective layer 205 provides both protective and nutritional benefits to the internal layers (e.g., any of the layers of pods 200, 250, 300, 350, or 400). For example, protective layer 205 may both provide protection during shipping against the environment, UV radiation, and contamination, while also providing nutritional benefits that transfer to the internal layers. The contact between the internal side of protective layer 205 and the inner layer (e.g., layers 210, 260, 410) allows for an interaction between the layers that can enhance or enrich the nutritional content of the inner layers. The nutritional benefits may be transferred from one layer to another as discussed above related to pod 200. For example, nutritional benefits or nutrients may be transferred from protective layer 205 to an inner layer (e.g., layers 210, 260, 410).

Pod 200 may contain multiple layers that release into liquid 110 sequentially over time. For example, pod 200 shown in FIG. 2B may dissolve into liquid 110 starting with layer 210, followed by layers 212 and 214 sequentially. Additionally, each layer may be configured to dissolve at a different rate from other layers, depending on the desired application. For example, layer 210 may dissolve very quickly to provide an immediate flavor, aroma, or other ingredient to liquid 110, or to simply expose the inner layers of pod 200 to liquid 110. Layer 212 may dissolve very slowly to gradually release its ingredient and to expose layer 214 at a later time. This enables changing flavors of the beverage over time. In this way, the layers may dissolve in a time-release manner, allowing for a changing beverage experience over time. Or, in the case of an iced beverage, the time release layers may be used to maintain a consistent flavor as ice melts in the beverage, which may otherwise dilute the beverage.

In some embodiments, layer 212 may include a nutrient or dietary supplement, such as a vitamin, and layer 212 may be a time-released layer to control the rate at which the nutrient or dietary supplement is consumed by the user. Layer 212 may include a food coloring or dye that releases slowly into the beverage over time.

A user may create a beverage using the time-release pod 200 by placing pod 200 in the liquid 110 (optionally removing or puncturing layer 210, in some embodiments). In the case of pod 200 shown in FIG. 2A, layer 212 may dissolve in a time-release manner to maintain a consistent flavor. In the case of a pod such as pod 200 shown in FIG. 2B, layer 212 may dissolve slowly, releasing layer 214 at a later time.

In the case of a pod 250 as shown in FIGS. 3A and 3B, layers 260 and 264 may serve as membranes that control the time-release mechanism. Pod 250 may contain ingredients that include a control mechanism that limits the rate of dissolution or release of the ingredient. For example, layer 260 may be quickly dissolved upon addition of pod 250 to liquid 110 (or optionally removed or punctured prior to adding pod 250 to liquid 110, in some embodiments). Upon exposure to liquid 110, layer 262 is released into liquid 110, thereby exposing layer 264 to liquid 110. Layer 264 may be a slow-release membrane that exposes layer 266 after an extended period of time (e.g., 10 minutes, 30 minutes, 60 minutes, or 90 minutes or more). In some embodiments, as shown in FIG. 2, layer 214 may be slow release and include a beverage ingredient. In this configuration, layer 214 may release a controlled amount of the ingredient over time. The rate at which the time-release layers dissolve can vary depending on the application. The layer may dissolve in a few minutes (e.g., 1 min, 2 min, 5 min, or 10 min) or the layer may dissolve over the course of several hours (e.g., 1 hour, 2 hours, 5 hours, or 10 hours).

The layers of pod 200 may also be configured to release into liquid 110 differently depending on properties of liquid 110, such as its temperature. For example, outer layer 210 may be designed to dissolve in hot water, and inner layer 212 may be designed to dissolve in cold water. Using this configuration, a user could add pod 200 to hot water, for example in the morning, to make a coffee, then add cold water later in the day to make an iced beverage. As another example, outer layer 210 may be designed to dissolve in cold water, and layer 212 may be designed to dissolve in hot water. Specifically, for layers designed to dissolve in hot water, the hot water may swell the pod and increase porosity, which causes the hot water to contact a greater surface area of the layer, increasing the rate of dissolution and releasing the contents of the pod. Using this configuration, a user could place pod 200 in a cold beverage and allow layer 210 to dissolve into the drink (e.g., to make an iced beverage to have with dinner). The remaining inner layer 212 would remain in the beverage until a hot beverage is applied to pod 200 (e.g., to make an after-dinner coffee). Once a hot beverage is applied, layer 212 will dissolve. For example, the layers of pod 200 may dissolve in a chilled liquid (i.e., a liquid that at a temperature less than or equal to 50° F., 45° F., 40° F., or 35° F.). The layers of pod 200 may dissolve in a hot liquid (i.e., a liquid that is at a temperature greater than or equal to 120° F., 140° F., 150° F., 160° F., 170° F., 180° F., 190° F., or 200° F.).

Additionally the pod may be configured to dissolve differently depending on the type of beverage, independent of temperature. For example, layer 210 may dissolve in carbonated water or other carbonated beverage while other layers, such as layers 212 or 214 may dissolve in either carbonated or still liquid.

Similarly, pod 200, 250, 300, 350, or 400 (or individual layers thereof) may be configured to dissolve only in acidic drinks, such as coffee or soda, or only in basic or alkaline drinks, such as an herbal tea. Additionally, each individual layer may be designed to dissolve differently based on the application. For example, layer 212 may be an acid-soluble layer that dissolves only in acidic drinks, while layer 214 may dissolve only in basic or alkaline drinks. In this manner, a user could create a beverage using pod 200 by removing or puncturing layer 210, adding pod 200 to a cup of coffee in the morning, allowing layer 212 to dissolve. Layer 214 would not dissolve in the coffee, but then later in the day, the user could pour a basic or alkaline drink, such as herbal tea, in the same cup, and layer 214 would dissolve. In some embodiments, an acid-soluble layer (e.g., layer 212) may dissolve in an acidic liquid (i.e. a liquid that has a pH less than 7.0 or less than or equal to 6.5, 6.0, 5.5, 5.0, 4.5, 4.0, 3.5, 3.0, 2.5, or 2.0)

Solubility parameters may be used to ensure that a particular layer (e.g., any of the layers discussed herein) dissolves only in a certain type of liquid (i.e., in only acidic liquid or only alkaline liquid). Specifically, solubility parameters of the substances used in the layer may be matched to make dissolvable films that can be swelled in acidic or basic media. For example, certain functional groups may be added to the polymer backbone of PHA, PVOH or PLA or cellulose esters, which makes it possible to make dissolvable films that dissolve only in an acidic drink or only in an alkaline drink. By swelling the polymer, it is possible to induce porosity for the desired liquid media to penetrate the film—thereby enhancing its solubility and releasing the ingredient.

In some embodiments, the layer dissolves only in an acidic drink and includes an ingredient that is a sparingly soluble salt derived from weak acids. As used herein, “sparingly soluble” refers to a solute that requires about 30 mL to about 100 mL of solvent to dissolve 1 gram of solute. Such salts tend to be more soluble in acidic solutions. In the presence of acidic media (i.e., low pH), the solubility of the sparingly soluble salt is increased. The salts may be blended with the material that makes up the layer, or it may be added to the backbone of the polymer in a polymer-based film, such as polylactic acid or cellulose acetate. Alternatively, the layer may include binding agents that are selectively soluble in acidic or basic media. In an acidic medium, the selectively soluble binding agent dissolves completely, thereby releasing the dissolvable component (e.g., polyvinyl alcohol and other flavors) into the acidic media. The layer may include esters, such as polyhydroxyalkanoates, cellulose esters, or polyanhydrides that can be sparingly soluble in basic media. Examples of such sparingly soluble salts include food-grade monocalcium phosphate monohydrate and salts of fatty acids (e.g., calcium stearate as food additive E470 and magnesium stearate).

In some embodiments, outer layer 210 is not removed or punctured, but rather may dissolve, and may contain a beverage ingredient that is itself used to make the beverage. For example, a user may drop pod 200 directly into a cup containing liquid 110, and outer layer 210 may be released into liquid 110 upon contact. Following the release of outer layer 210, any inner layers, for example layers 212 and 214 may be released into liquid 110.

Additionally, a single pod 200 may have some layers that are released based on temperature, and some layers that are released based on the type of beverage. For example, pod 200 may have outer layer 210 that releases in a hot liquid, and inner layer 212 that releases in a carbonated beverage. In this way, a user could add pod 200 to a cup of coffee in the morning, releasing outer layer 210, but leaving inner layer 212 intact. Then, later in the day, the user may add, for example, carbonated water to the same cup and inner layer 212 will dissolve.

As another example, pod 200 may have outer layer 210 that releases in a hot liquid, and inner layer 212 that releases in an alkaline beverage. In this way, a user could add pod 200 to a cup of hot coffee in the morning, releasing outer layer 210, but leaving inner layer 212 intact. Then, later in the day, the user may add hot or iced alkaline drink (e.g., herbal tea) to the same cup, and the alkalinity in the alkaline drink will cause inner layer 212 to release in to the liquid.

In addition to having multiple layers pod 200 may have multiple chambers that are adjacent to one another, rather than layered, within the same pod.

FIGS. 5A-5C show various configurations of a multiple-chamber pod. FIG. 5A shows a pod 300 with chambers 310, 312, 314, 316, and 318. FIG. 5B shows another variation, with a pod 350 having chambers 360, 362, and 364. Each individual chamber may be used in a similar manner as the layers described previously with respect to pod 200 to provide timed release of various ingredients, sequential release, simultaneous release, or application-specific release.

In some embodiments, as shown in FIG. 5C, layer 410 may be used to both separate chamber 412 from chamber 414 and surround the exterior surface of chamber 412 and chamber 414. In some embodiments, layer 410 is a gel. In some embodiments, layer 410 is a solid. Using this configuration, both chamber 412 and chamber 414 will be exposed to the beverage upon the dissolution of layer 410 into the beverage. Thus, both chamber 412 and chamber 414 will be mixed simultaneously, rather than sequentially, as is the case related to pod 200 shown in FIG. 3A. Chambers 412 and 414 may be any combination of solids, liquids, or gels.

The pods may have both multiple chambers and one or more layers. For example, FIG. 5C shows pod 400 configured to have a layer 410, a first chamber 412, and a second chamber 414. Layer 410 may separate first chamber 412 from second chamber 414 and completely cover both first chamber 412 and second chamber 414. Additionally, each chamber may have multiple layers within each chamber, similar to the multiple layers shown in FIGS. 2A-3B.

In some embodiments, pod 200 may be designed to give off an aroma while one or more of the layers dissolve into liquid 110. For example, pod 200 shown in FIG. 2A may contain an aromatic outer layer 210 that gives off an aroma while being dissolved into liquid 110. Following dissolution of aromatic outer layer 210, inner layer 212 may be exposed and released into liquid 110 while the aroma from layer 210 is still present.

In some embodiments, pod 200 may be ready for immediate consumption by a user, without adding pod 200 to a beverage. Pod 200 may be edible or drinkable immediately upon removal from a package. For example, the user may peel off an outer protective layer, such as protective layer 205 shown in FIG. 4, then immediately consume the rest of pod 200. For example, the user may remove the protective layer and then place the pod directly into his or her mouth and consume the pod immediately. In some embodiments, the pod is configured such that the user can place the pod directly in his or her mouth, bite into the outer layer, consume a liquid contained within, and dispose of the outer layer. In some embodiments, the entire pod, including the outer layer and any inner layers, may be configured such that the user can bite directly into the pod and consume the entire pod, without the need to dispose of any layers. Alternatively, pod 200 may be housed among other similar pods in a larger package without a protective layer, and the user may retrieve pod 200 from the larger package and consume it directly.

Pod 200 may be an edible solid, gel, or liquid that provides a flavor when added to liquid 110 or when burst by the user. For example, pod 200 may include outer layer 210 and inner layer 212 as shown in FIG. 2A. Outer layer 210 may be a membrane or otherwise solid layer that is burst by the user before placing pod 200 into liquid 110. Inner layer 212 may be a flavored solid or liquid that is released upon contact with liquid 110 after the user bursts outer layer 210. As another example, the user may place pod 200 into liquid 110 in a container, such as container 700 shown in 6C, and shake the container until the force from shaking bursts outer layer 210. The bursting of outer layer 210 releases flavor into the beverage.

Inner layers of pod 200, such as layers 212, 214, and 216, may be a gel or a liquid that contains inclusions within the layer. The inclusions may be solids that either dissolve into liquid 110 or remain solid in liquid 110 after outer layer 210 has been released into the beverage. The inclusions may be any kind of solid. Non-limiting examples of inclusions include basil seeds, chia seeds, fruit pieces, tapioca (such as that used in bubble tea), and any other solid suitable for use in a beverage.

In some embodiments, the inclusions are frozen inside of a liquid to form a layer, such as inner layer 212 as shown in FIG. 2A. Following freezing, inner layer 212 may be surrounded by a gel or a solid to form outer layer 210 and complete pod 200.

In some embodiments, layer 212 is a liquid and the inclusions are also a liquid. Liquid layer 212 and liquid inclusions may be combined in the form of an emulsion prepared by mixing the two liquids with an emulsifying agent. In some embodiments, the emulsifying agent is water-soluble. Suitable emulsifying agents include agar, lecithin, diacetyl, tartaric acid esters, alginates, monosodium phosphates, gum acacia, modified starch, carboxymethylcellulose, gum tragacanth, gum ghatti, and other suitable gums. In some embodiments, the emulsifying agent makes up about 3% to about 30% of the mixture of liquid layers 212, the liquid inclusions, and the emulsifying agent.

The inclusions, whether solid or liquid, may be insoluble in the pod but soluble in the beverage liquid. In this way, the contents of the inclusions do not mix with the rest of the pod until the pod is placed in the beverage liquid, enabling the creation of a freshly-made beverage.

Pods 200, 250, 300, 350, and 400 may be used and activated by dropping the pod in liquid 110, as shown in FIGS. 1A and 1B. Pods 200, 250, 300, 350, and 400 may vary in size depending on the application. For example, the pods may be single-serve sizes or multi-serve sizes. Single-serve pods may be designed for one pod per beverage serving, for example one pod per 8 oz. beverage, 20 oz. bottle, or other single-serve beverage. Multi-serve pods maybe larger for use with larger format beverages, for example one pod per 2 liter pitcher. Alternatively, the pods may be smaller and require multiple pods for a single serving, which can allow a user to adjust the taste of the beverage based on user preferences. For example, a user who prefers a bold-flavored beverage may use 2 or more pods, and user who prefers a mild-flavored beverage may use a single pod.

In some embodiments, a single-serve pod may have a volume from 1 mL to 15 mL (e.g., 1 mL, 2 mL, 5 mL, 10 mL, or 15 mL). Multi-serve pods may have a volume of 1 mL to 50 mL (e.g., 1 mL, 5 mL, 10 mL, 20 mL, 30 mL, 40 mL, or 50 mL).

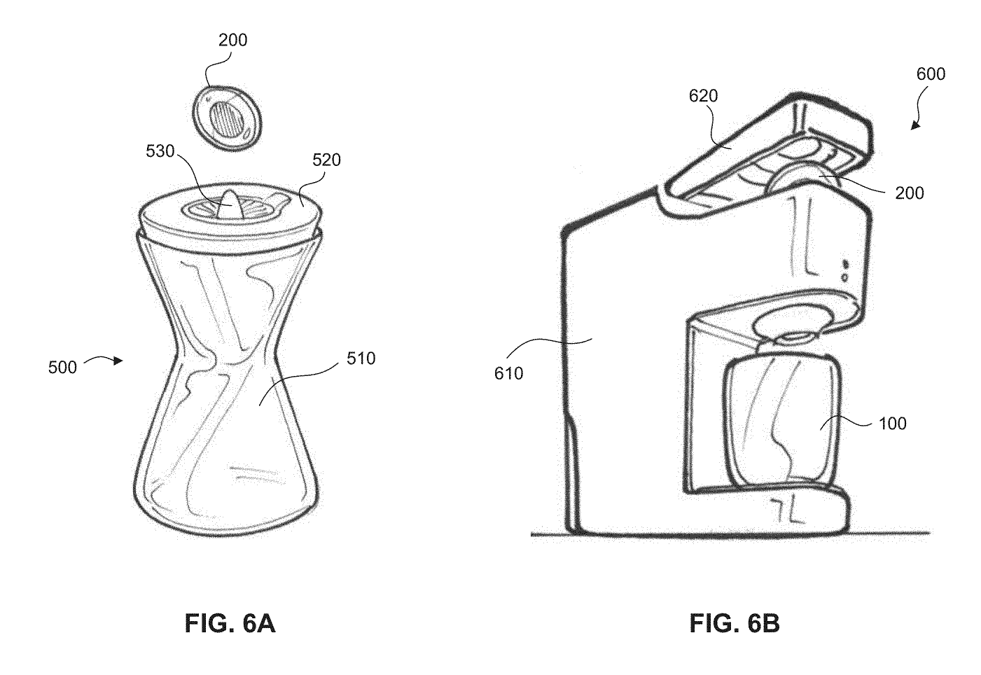

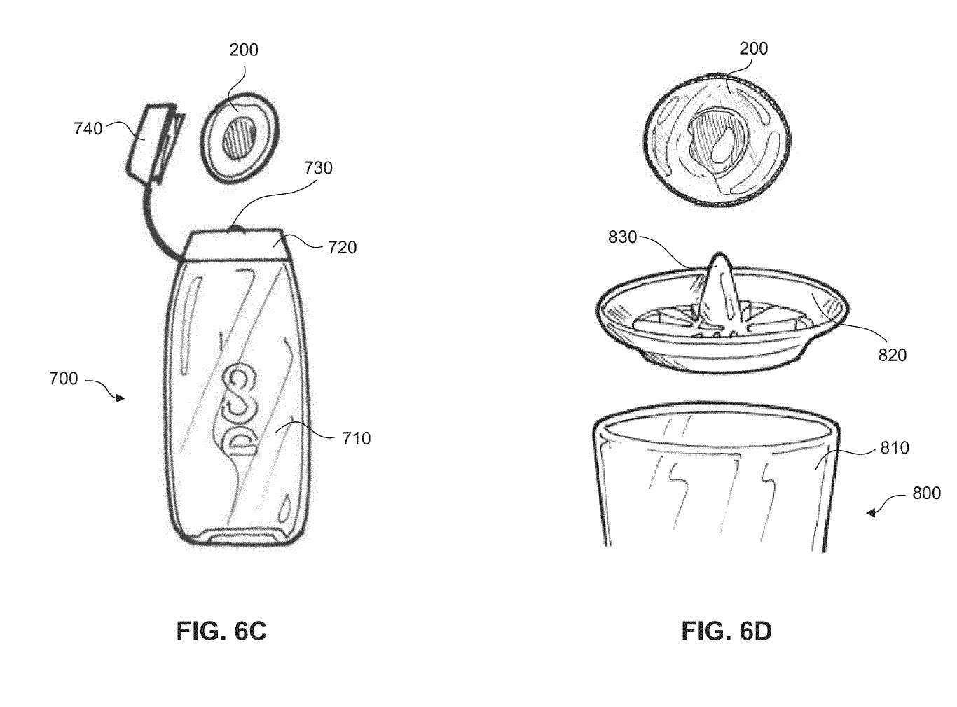

In some embodiments, pods 200, 250, 300, 350, or 400 are activated by bursting or piercing the pod. All layers of the pod may be punctured at the same time, releasing all of the contents at one time. The pod may be punctured by a user or by a device made for puncturing the pod. In some embodiments, pods 200, 250, 300, 350, and 400, may be used in conjunction with a variety of devices and vessels. FIGS. 6A-6D show various types of devices and vessels that may be used with the pods. Though FIGS. 6A-6D show pod 200, it is to be understood that pods 250, 300, 350, or 400 may also be used. Additionally, any of the configurations of pods 200, 250, 300, 350, or 400 may be used with the equipment shown in FIGS. 6A-6D.

FIG. 6A shows a container 500, which has a lower portion 510, an upper portion 520, and a piercer 530. Using container 500, pod 200 is placed on upper portion 520, and outer layer 210 may be burst by piercer 530. Piercer 530 may pierce through all layers to release all of the contents of pod 200 into lower portion 510 of container 500.

FIG. 6B shows a device 600, which has a body portion 610 and a lid 620. Pod 200 may be placed in a depression formed in the top part of body portion 610, and lid 620 may be placed over pod 200 to enclose the pod within device 600. Device 600 may also include a water reservoir or other water source and a pump that provides a water stream to apply to pod 200. The contents of pod 200 may dissolve into the water stream as the water contacts and washes over pod 200, creating a beverage that is dispensed in cup 100.

FIG. 6C shows a container 700, which includes a base 710, a pod receiver 720, a piercer 730, and a lid 740. Using container 700 pod 200 may be placed in pod receiver 720, and piercer 730 pierces through all layers of pod 200 to release all of the contents of pod 200 may be dispensed into base 710 when lid 740 is placed over pod 200. Pod 200 may remain in pod receiver 720 after lid 740 has been closed, or pod 200 may be removed from pod receiver 720 before lid 740 has been closed. Adding water to base 710 before or after the contents of pod 200 are added creates a ready-made beverage.

FIG. 6D shows another container 800, which includes a base 810 and a pod receiver 820. A beverage is produced using container 800 in a similar manner as with container 700. The contents of pod 200 may be dispensed by a user placing pod 200 on pod receiver 820 and applying pressure to burst the outer layer of pod 200.

Although certain examples may describe an example using one of pods 200, 250, 300, 350, or 400, it is to understood that any of the examples herein may be applied to any of pods 200, 250, 300, 350, or 400.

Regardless the configuration of pod 200, 250, 300, 350, or 400, the materials may all be environmentally friendly. Protective layer 205 may be made for disposal in the sink, trash, or compost. Additionally, because of the small amount of packaging required for each pod, the pods may be e-commerce friendly and able to be sold and shipped in multipacks.

It may be possible to use pods 200 without protective layer 205 for in-home or personal use. Sanitation and hygiene in the food and beverage industry are very important. For this reason, if pods 200 are used in a commercial setting, protective layer 205 may be designed to ensure sanitation until the end user receives the pod or the beverage.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

What is claimed is:

1. An ingredient pod for making a beverage, the pod comprising:
a first layer defining an outer surface of the pod;
a second layer disposed within the first layer, the second layer comprising a first beverage ingredient;
a third layer disposed within the second layer, the third layer comprising a second beverage ingredient,
wherein the first beverage ingredient is a solid, a liquid, or a gel,
wherein at least one of the first beverage ingredient and the second beverage ingredient is a solid, and
wherein the first beverage ingredient and the second beverage ingredient are configured to release into a beverage liquid in response to immersion of the pod within the beverage liquid.

2. The pod of claim 1, further comprising a membrane removably disposed exterior to the first layer such that the membrane covers the first layer.

3. The pod of claim 1, wherein the first layer comprises a nutrient configured to be transferred to the second layer.

4. The pod of claim 3, wherein the first layer is removable.

5. The pod of claim 1, wherein the first layer is a membrane configured to control the release of the second layer into the beverage.

6. The pod of claim 5, wherein the membrane is dissolvable in the beverage liquid.

7. The pod of claim 5, further comprising a fourth layer disposed between the second layer and the third layer, wherein the fourth layer is a membrane configured to control the release of the third layer into the beverage.

8. The pod of claim 7, wherein the fourth layer comprises an edible and dissolvable gel.

9. The pod of claim 1, wherein the second layer and the third layer can both dissolve in water to form a beverage.

10. The pod of claim 1, wherein the second layer and the third layer dissolve sequentially in the beverage liquid to form a beverage.

11. The pod of claim 7, wherein:
the first layer comprises a gel,
the second layer comprises a concentrate,
the third layer comprises a gel,
the fourth layer comprises a solid, and
the first layer and the third layer are both biodegradable.

12. The pod of claim 1, further comprising:
a fifth layer comprising a third beverage ingredient,
wherein the third beverage ingredient comprises one of a solid, a gel, or a liquid.

13. The pod of claim 1, wherein the first beverage ingredient is a solid that dissolves in the beverage liquid to form a beverage.

14. The pod of claim 1, wherein the first layer is configured to dissolve only when exposed to a liquid having a pH less than or equal to 6.5.

15. The pod of claim 1, wherein the first layer is configured to dissolve only when exposed to a liquid at a temperature of greater than or equal to 170° F.

16. The pod of claim 1, wherein:
the first layer forms a plurality of chambers, and
the second layer and the third layer are disposed in one of the chambers.

17. The pod of claim 16, further comprising a membrane surrounding the plurality of chambers, wherein the membrane comprises a removable and biodegradable film.

18. The pod of claim 1, wherein the beverage liquid comprises one of water, carbonated water, juice, coffee, tea, or soda.

19. An ingredient pod for making a beverage, the pod comprising:
a first chamber comprising a first beverage ingredient;
a second chamber disposed adjacent to the first chamber, the second chamber comprising a second beverage ingredient;
a first membrane defining the first chamber and a second membrane defining the second chamber, the first membrane and the second membrane each formed of an edible and dissolvable gel.

20. The pod of claim 19, wherein the first membrane is continuous with the second membrane.

21. The pod of claim 19, wherein the second membrane is discontinuous with the first membrane and wherein the second membrane is disposed within the first chamber.

22. The pod of claim 21, wherein at least one of the first chamber and the second chamber comprises a third beverage ingredient not mixed with the first beverage ingredient or the second beverage ingredient.

23. The pod of claim 19, wherein:
the first beverage ingredient is a concentrate, and
the second beverage ingredient is a solid.

24. The pod of claim 19, wherein at least one of the first membrane and the second membrane comprises a nutrient, and wherein the nutrient transfers to the first beverage ingredient or the second beverage ingredient through contact with the first membrane or the second membrane.
